(19) United States
(12) Patent Application Publication
(10) Pub. No.: US 2023/0419183 A1
(43) Pub. Date: Dec. 28, 2023

(54) UTILIZING MACHINE LEARNING MODELS TO INTELLIGENTLY TRANSMIT PRE-EMPTIVE DIGITAL NOTIFICATIONS TO CLIENT DEVICES ACROSS COMPUTER NETWORKS

(71) Applicant: Chime Financial, Inc., San Francisco, CA (US)

(72) Inventor: David Purdy, Millbrae, CA (US)

(21) Appl. No.: 18/333,884

(22) Filed: Jun. 13, 2023

Related U.S. Application Data
(60) Provisional application No. 63/367,000, filed on Jun. 24, 2022.

(51) Int. Cl. G06N 20/00

(52) U.S. Cl. CPC G06N 20/00

(57) ABSTRACT

The present disclosure relates to systems, non-transitory computer-readable media, and methods for utilizing trained machine learning models to generate digital asset availability predictions and client intent classifications for providing pre-emptive digital notifications to client devices. In particular, the disclosed systems can utilize a decision availability prediction machine learning model trained based on historical data to generate a predicted asset availability time for a client account. In addition, in one or more implementations the pre-emptive notification system utilizes an intent prediction machine learning model to generate a digital intent classification. The pre-emptive notification system analyzes the predicted asset availability time and the digital intent classification to generate a pre-emptive digital notification. For example, the pre-emptive notification system can determine that the digital intent classification satisfies a threshold intent probability and provide a pre-emptive digital notification to a client device corresponding to the account regarding the predicted asset availability time.

### CROSS-REFERENCE TO RELATED APPLICATIONS

This application claims the benefit of, and priority to, U.S. Provisional Application No. 63/367,000, filed on Jun. 24, 2022. The aforementioned application is incorporated by reference in its entirety.

### BACKGROUND

Recent years have seen significant improvements in conventional systems for utilizing computing devices to interact with various client devices. For example, conventional systems can utilize computer-implemented chat bots or machine learning models to guide clients through various options and identify desired information or services. Although conventional systems can autonomously interact with clients, these conventional systems have a number of problems in relation to accuracy, efficiency, and flexibility of implementing computing devices.

For instance, conventional systems are often inefficient in providing digital information to client devices. Indeed, conventional systems often wait until client devices interact with implementing servers and then expend significant resources in addressing queries and providing digital information to the client devices in a reactive manner. This reactive approach is inefficient because responding to queries and utilizing chatbots or artificial intelligence to guide client devices to pertinent information takes a significant amount of time and computing resources. For example, conventional systems waste significant time and computational resources (e.g., memory and processing power) in providing user interfaces for client devices to search for desired information. Similarly, conventional systems require backend training and implementation of machine learning models for interacting with client devices, interaction with supporting systems for querying and providing requested information, and significant bandwidth to transfer repeated interactions and responses across computer networks as client devices interact with various interfaces and workflows.

Conventional systems are also inefficient because they lead to repetitive user interactions. Indeed, for client devices seeking updates regarding digital assets corresponding to a client account, conventional systems often require client devices to repeatedly query implementing servers to obtain pertinent digital information. This only exacerbates the inefficiencies discussed above, as client devices repeatedly interact with computationally expensive resources.

In addition, conventional systems are also inflexible and rigid. Indeed, conventional systems rigidly approach client device queries in a reactive approach which limits flexibility. Indeed, conventional systems rigidly react to queries as client devices interact with implementing servers, which provides conventional systems with no control over the computational demand or resources needed to respond to such queries. Furthermore, conventional systems react to client devices without having any ability to control the number of client devices seeking information over time. This inflexibility only further aggravates the efficiency problems discussed above as conventional systems rigidly reserve bandwidth, memory, and processing power to respond to waves of client device queries over time.

These along with additional problems and issues exist with regard to conventional systems.

### SUMMARY

This disclosure describes one or more embodiments of methods, non-transitory computer-readable media, and systems that can solve the foregoing problems in addition to providing other benefits by utilizing machine learning models to intelligently transmit pre-emptive digital notifications to client devices across computer networks. For example, the disclosed systems utilize a trained availability prediction machine learning model (e.g., a decision tree model or neural network) to generate a digital asset availability prediction for a client account. Similarly, the disclosed systems generate a digital intent classification for the client account utilizing an intent prediction machine learning model. In one or more implementations, the disclosed systems leverage the digital intent classification and/or the digital asset availability prediction to transmit a pre-emptive digital notification to a client device corresponding to the client account. For example, the disclosed systems can generate a digital asset availability prediction indicating that an account asset will be available by a predicted asset availability time. The disclosed systems can also generate a digital intent classification indicating that a client satisfies a threshold probability of having a query intent regarding the account asset. In response, the disclosed systems can provide a pre-emptive digital notification regarding the predicted asset availability time. In this manner, the disclosed systems can generate pre-emptive digital notifications that efficiently and flexibly provide pertinent information to client devices.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a block diagram of an environment for implementing a pre-emptive notification system in accordance with one or more embodiments.

FIG. 2 illustrates an example diagram of a pre-emptive notification system that utilizes various machine learning models to generate and provide pre-emptive digital notifications in accordance with one or more embodiments.

FIG. 3 illustrates an example diagram of a pre-emptive notification system utilizing an availability prediction machine learning model and an intent prediction machine learning model to generate and provide a pre-emptive digital notification in accordance with one or more embodiments.

FIG. 4 illustrates an example diagram of a pre-emptive notification system providing a plurality of notifications to a client device in accordance with one or more embodiments.

FIG. 5 illustrates an example diagram of a pre-emptive notification system training one or more machine learning models in accordance with one or more embodiments.

FIG. 6 illustrates an example series of acts for intelligently transmitting pre-emptive digital notifications to client devices across computer networks in accordance with one or more embodiments.

FIG. 7 illustrates a block diagram of a computing device for implementing one or more embodiments of the present disclosure.

FIG. 8 illustrates an example environment for a pre-emptive notification system in accordance with one or more embodiments.

### DETAILED DESCRIPTION

This disclosure describes one or more embodiments of a pre-emptive notification system that utilizes trained machine learning models to generate digital asset availability predictions and client intent classifications for providing pre-emptive digital notifications to client devices. To elaborate, the pre-emptive notification system can utilize a decision availability prediction machine learning model trained based on historical data to generate a predicted asset availability time for a client account. In addition, in one or more implementations the pre-emptive notification system utilizes an intent prediction machine learning model to generate a digital intent classification. The pre-emptive notification system analyzes the predicted asset availability time and the digital intent classification to generate a pre-emptive digital notification. For example, the pre-emptive notification system can determine that the digital intent classification satisfies a threshold intent probability and provide a pre-emptive digital notification to a client device corresponding to the account regarding the predicted asset availability time.

In one or more embodiments, the pre-emptive notification system extracts client features corresponding to a client/client device and then utilizes these features with various machine learning models to generate pre-emptive digital notifications. For instance, the pre-emptive notification system can monitor client device interactions, determine client device characteristics, and access digital accounts corresponding to the client device to extract features. To illustrate, the pre-emptive notification system can determine a client's recent activity, historical digital asset patterns, or previous client intent classifications.

Upon determining client features, the pre-emptive notification system utilizes various machine learning models in generating and providing a pre-emptive digital notification. For example, the pre-emptive notification system can utilize a decision availability prediction machine learning model to generate a predicted asset availability time for a client account (e.g., a particular time for which an account asset, such as a direct deposit, will become available within a client account). Similarly, the pre-emptive notification system can utilize an intent prediction machine learning model to generate digital intent classifications. For example, the pre-emptive notification system can generate a plurality of intent classifications and a corresponding plurality of intent classification probabilities. The pre-emptive notification system can utilize these intent classification probabilities (and/or an intent classification threshold) to determine a digital intent classification for a client account.

In some implementations, the pre-emptive notification system utilizes the digital intent classification and predicted asset availability time to generate a pre-emptive digital notification. For example, in some implementations, the pre-emptive notification system selects a trigger notification event (e.g., an event indicating that a client is opening a mobile application or that a transmission time relative to the predicted asset availability time has been satisfied). Upon detecting the trigger notification event, the pre-emptive notification system provides a pre-emptive digital notification to a client device regarding the account asset and/or the predicted asset availability time.

In one or more embodiments, the pre-emptive notification system also provides additional digital notifications. For example, upon detecting a status progression event with regard to the account assets, the pre-emptive notification system can provide an additional notification regarding the status progression event. Similarly, upon detecting that the predicted asset availability time has passed, the pre-emptive notification system can provide an additional notification (e.g., indicating a new predicted asset availability time).

As mentioned above, the pre-emptive notification system can train machine learning models as well. In some embodiments, the pre-emptive notification system trains the machine learning model to utilize extracted client features and monitored client account events as ground truths for supervised training. In some implementations, the pre-emptive notification system utilizes predicted asset available times and ground truth asset available times to train a decision availability prediction machine learning model. Similarly, the pre-emptive notification system utilizes predicted client intent classifications for a client device and monitored interactions to train an intent prediction machine learning model.

As suggested above, the disclosed pre-emptive notification system provides several improvements or advantages over conventional systems. For example, the pre-emptive notification system can improve inefficiencies of conventional systems by reducing the overall burden on implementing devices. For example, the pre-emptive notification system can utilize trained machine learning models to generate pre-emptive digital notifications that reduce (or remove) the need to respond to computationally expensive client device queries. Indeed, the pre-emptive notification system can provide pre-emptive digital notifications that provide needed digital information without initiating chat bots or utilizing automated artificial intelligence interaction models to interact with client devices. Moreover, the pre-emptive notification system can provide pre-emptive digital notifications that include needed information in a single user interface, thus reducing time, user interactions, and user interfaces needed to determine and provide the digital information. Accordingly, the pre-emptive notification system can reduce interaction times, user interfaces, automated artificial intelligence models and interactions, and computing resources.

Furthermore, the pre-emptive notification system also reduces computing resources resulting from duplicative or repetitive client device interactions. Indeed, the pre-emptive notification system can iteratively provide pre-emptive digital notifications (or other notifications) as additional events are detected regarding a client account. By providing these notifications, the pre-emptive notification system avoids the computational expense associated with duplicative interactions between automated interaction systems (such as chatbots) and querying client devices.

In addition, the pre-emptive notification system can improve inaccuracies of conventional systems by generating a digital asset availability prediction and digital intent classification utilizing machine learning approaches. For example, by utilizing trained machine learning models and extracted features corresponding to a client, the pre-emptive notification system can predict an accurate time that account assets will be available and an accurate client intent. Moreover, the pre-emptive notification system can utilize these signals to more accurately transmit digital notifications (at a more accurate/appropriate time) that anticipate future client device queries. Accordingly, the pre-emptive notification system can utilize implementing computer devices to determine and provide accurate pre-emptive digital notifications at more accurate times.

The pre-emptive notification system can also improve the inflexibility and rigidity of conventional systems. For example, the pre-emptive notification system can generate pre-emptive digital notifications that flexibly control the client devices that interact with implementing servers/devices. Moreover, the pre-emptive notification system flexibly identifies trigger notifications events and flexibly provides pre-emptive digital notifications (e.g., when most appropriate for a particular client device and predicted intent). Accordingly, the pre-emptive notification system flexibly transmits digital information to client devices over time to further improve the performance of implementing computer devices.

As indicated by the foregoing discussion, the present disclosure utilizes a variety of terms to describe features and advantages of the pre-emptive notification system. For example, as used herein, the term “pre-emptive digital notification” refers to a digital communication or notification provided to a client device (e.g., in anticipation of the client device submitting a query regarding a particular topic or intent). Thus, for example, a pre-emptive digital notification includes a digital notification provided to a client device regarding an anticipated topic or intent (e.g., without receiving a query regarding the topic or intent).

Moreover, the term “digital intent classification” refers to a class or category indicating a purpose, disposition, intent, reason, desire, or objective for a client. In particular, a digital intent classification can include a probable intention of the client, determined by a machine learning model trained on past interaction and informed by client features. To illustrate, a predicted client intent classification can include a prediction that a client is interested in a direct deposit status, interaction history, and/or device fee information.

As mentioned above, the pre-emptive notification system can include a predicted asset availability time. As used herein, a “predicted asset availability time” includes a predicted time that an asset will be available via a client account. Thus, for example, a predicted asset availability time includes a time that a direct deposit or transfer will be accessible via a client account.

As discussed, the pre-emptive notification system can extract account features for use by the machine learning model. As used herein, the term “account features” refers to attributes, characteristics, behaviors, and/or interactions corresponding to a client, client device, or account. In particular, the term “account features” can include previous interactions, client balance, digital account status, and recent activity. To illustrate, account features can include that an account has been open for a total of two months, a direct deposit schedule (e.g., dates/times that direct deposits have been transferred, received, or available), an interaction schedule (e.g., the client has opened a mobile application to access an account five times in the past week), or that a client has recently received a communication regarding security issues with an account.

As mentioned, in one or more embodiments, the pre-emptive notification system uses a machine learning model. As used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks). In some implementations, the pre-emptive notification system can utilize different neural networks, such as recurrent neural networks (e.g., long short term neural networks or LSTMs), convolutional neural networks, transformers, and/or graph neural networks.

The pre-emptive notification system can use a machine learning model (e.g., an intent prediction machine learning model) to generate a digital intent classification with an intent classification probability. As used herein, the term intent classification probability refers to a likelihood of a particular intent classification. To illustrate, an intent classification probability can include a 65% probability that a client has a question about a direct deposit status (e.g., the client intends to contact a server or system regarding a direct deposit query). Similarly, the pre-emptive notification system can use a machine learning model (e.g., an availability prediction machine learning model) to generate a predicted asset availability time and/or asset availability probability.

As used herein, the term “trigger notification event” refers to an event that initiates a notification (e.g., an event that initiates a pre-emptive digital notification). For example, a trigger notification event can include a client device accessing a particular application, a particular day or time (e.g., a time of day, particular hour, or a periodic time frame), a client device contacting a server, or a client device accessing a client account.

As used herein, the term “status progression event” refers to an event indicating progress or advancement. In particular, a status progression event can include a preliminary approval or other event related to progress or advancement of an account asset (e.g., a direct deposit or other asset transfer).

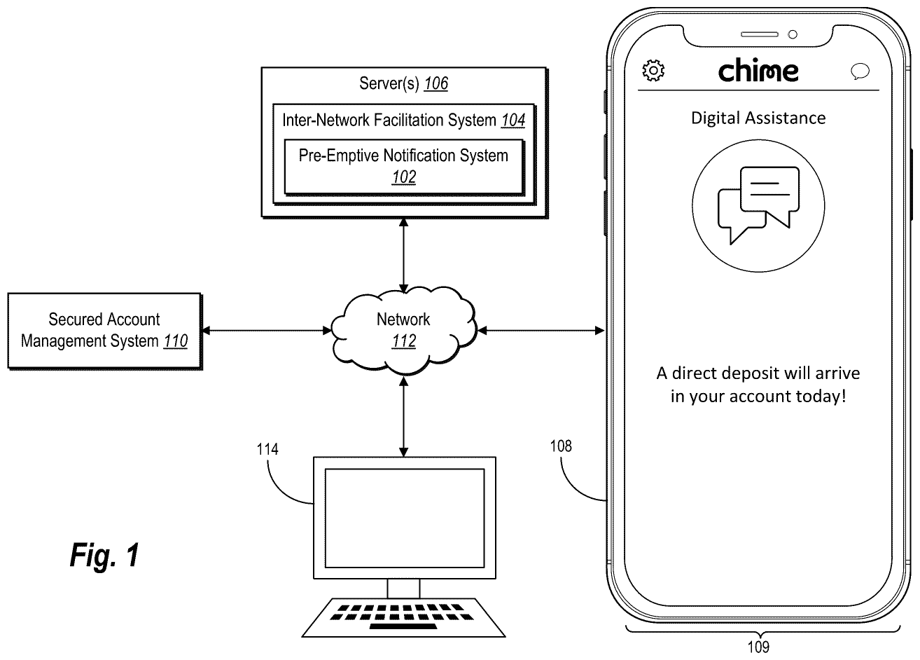

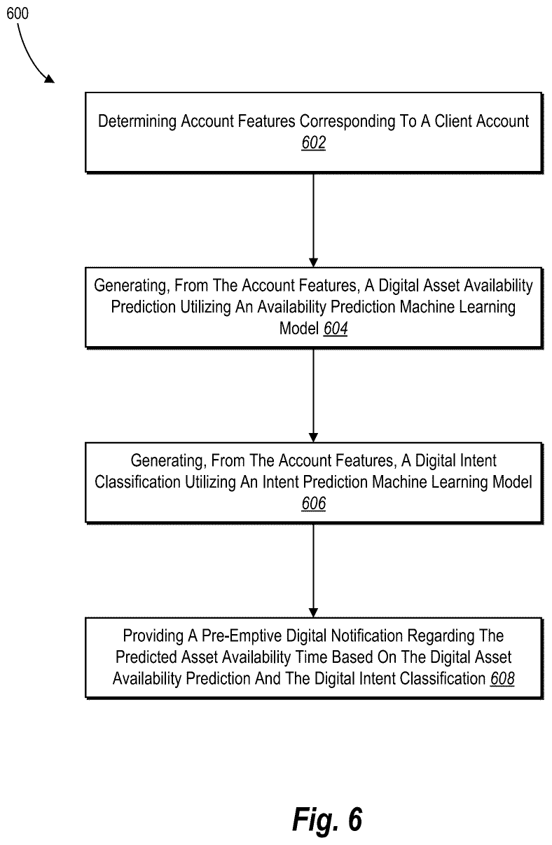

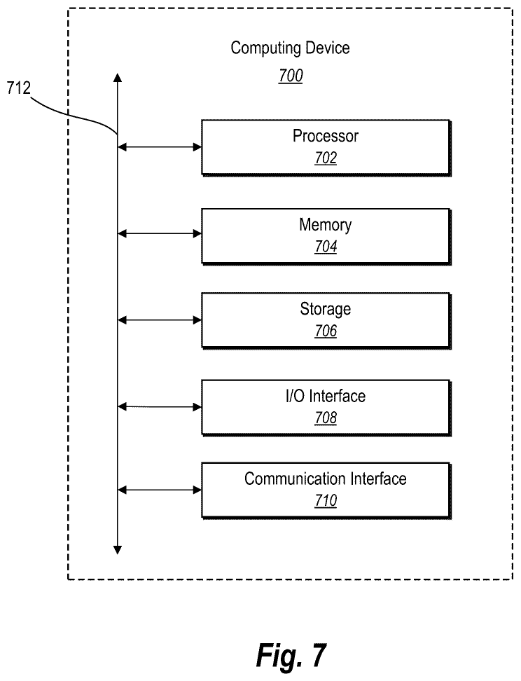

Additional detail regarding the pre-emptive notification system will now be provided with reference to the figures. In particular, FIG. 1 illustrates a block diagram of a system environment for implementing a pre-emptive notification system 102 in accordance with one or more embodiments. As shown in FIG. 1, the environment includes server(s) 106 implementing the pre-emptive notification system 102 as part of an inter-network facilitation system 104. The environment of FIG. 1 further includes a client device 108, a device application 109, an agent device 114, and a secured account management system 110. The server(s) 106 can include one or more computing devices to implement the pre-emptive notification system 102. Additional description regarding the illustrated computing devices (e.g., the server(s) 106, the client device 108, the agent device 114 and/or the secured account management system 110) is provided with respect to FIGS. 6-7 below.

As shown, the pre-emptive notification system 102 utilizes the network 112 to communicate with the client device 108, the agent device 114, and/or the secured account management system 110. The network 112 may comprise a network as described in relation to FIGS. 6-7. For example, the pre-emptive notification system 102 communicates with the client device 108 to provide a pre-emptive digital notification. Indeed, the inter-network facilitation system 104 or the pre-emptive notification system 102 can provide a pre-emptive digital notification to the client device 108 or can facilitate a session between the agent device 114 and the client device 108.

As described in greater detail below (e.g., in relation to FIG. 7), the inter-network facilitation system 104 can manage interactions across multiple devices, providers, and computer systems. For example, the inter-network facilitation system 104 can execute transactions across various third-party systems such as a banking entities, automated transaction machines, or payment providers. The inter-network facilitation system 104 can also maintain and manage digital accounts for client devices/users to store, manage, and/or transfer funds to other users.

In some embodiments, the inter-network facilitation system 104 or the pre-emptive notification system 102 communicates with the secured account management system 110. More specifically, the inter-network facilitation system 104 or the pre-emptive notification system 102 determines the identity and permissions of the client device 108 by communicating with the secured account management system 110. The pre-emptive notification system 102 can determine permissions of the client device 108 prior to disclosing secure information to the client device 108. For example, the inter-network facilitation system 104 or the pre-emptive notification system 102 accesses a secured account maintained by the secured account management system 110 (e.g., remotely from the server(s) 106) and determines the last direct deposit within the secured account.

In one or more embodiments, the inter-network facilitation system 104 or the pre-emptive notification system 102 communicates with the secured account management system 110 in response to the pre-emptive notification system 102 receiving identification information from the client device 108. In particular, the inter-network facilitation system 104 or the pre-emptive notification system 102 provides an indication of a secured account associated with a digital account to indicate that the client device 108 is authorized to receive information pertaining to the digital account. In addition, the inter-network facilitation system 104 or the pre-emptive notification system 102 communicates with the secured account management system 110 to determine permissions of the client device 108. For example, the inter-network facilitation system 104 or the pre-emptive notification system 102 provides information to the client device 108 such as direct deposit status, digital account updates, device fee information, check status, interaction history, order status, activation, etc.

As indicated by FIG. 1, the client device 108 includes the device application 109. In particular, the device application 109 can include a web application, a native application installed on the client devices 108 (e.g., a mobile application, a desktop application, etc.), or a cloud-based application where all or part of the functionality is performed by the server(s) 106. In some embodiments, the inter-network facilitation system 104 or the pre-emptive notification system 102 communicates with the client device 108 through the device application 109. This communication for example, receives and provides information including direct deposit status, digital account updates, device fee information, check status, interaction history, order status, activation, etc. As shown, the pre-emptive notification system 102 can provide pre-emptive digital notifications, digital account information, and secured account information for display within a graphical user interface associated with the device application 109.

As shown in FIG. 1, the client device 108 implements the device application 109 in conjunction with interaction with the inter-network facilitation system 104 or the pre-emptive notification system 102. For example, the inter-network facilitation system 104 or the pre-emptive notification system 102 can monitor the activities of the device application 109. In particular, these activities can include events such as time spent on device application 109, recently viewed pages on device application 109, the most recent activation activity of the device application 109, etc.

Although FIG. 1 illustrates the environment having a particular number and arrangement of components associated with the pre-emptive notification system 102, in some embodiments, the environment may include more or fewer components with varying configurations. For example, in some embodiments, the inter-network facilitation system 104 or the pre-emptive notification system 102 can communicate directly with the client device 108, device application 109, and/or the secured account management system 110, bypassing the network 112. In these or other embodiments, the inter-network facilitation system 104 or the pre-emptive notification system 102 can be implemented (entirely on in part) on the client device 108. Additionally, the inter-network facilitation system 104 or the pre-emptive notification system 102 can include or communicate with a database for storing information, such as direct deposit status, digital account updates, device fee information, check status, interaction history, order status, activation, and/or other information described herein.

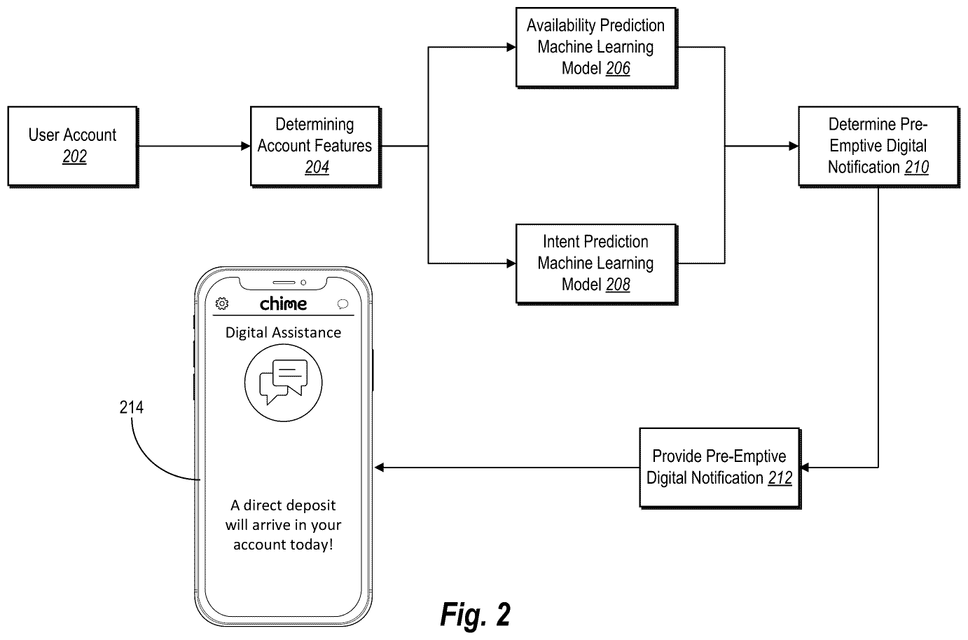

As discussed above, the pre-emptive notification system 102 can provide pre-emptive digital notifications to a client device. For example, FIG. 2 illustrates an overview of the pre-emptive notification system 102 utilizing an availability prediction machine learning model 206 and an intent prediction machine learning model 208 to provide a pre-emptive digital notification to a client device 214. More specifically, as illustrated in FIG. 2, the pre-emptive notification system 102 determines account features corresponding to the client device 214 and/or user account 202 and uses the availability prediction machine learning model 206 and the intent prediction machine learning model 208 to determine pre-emptive digital notifications.

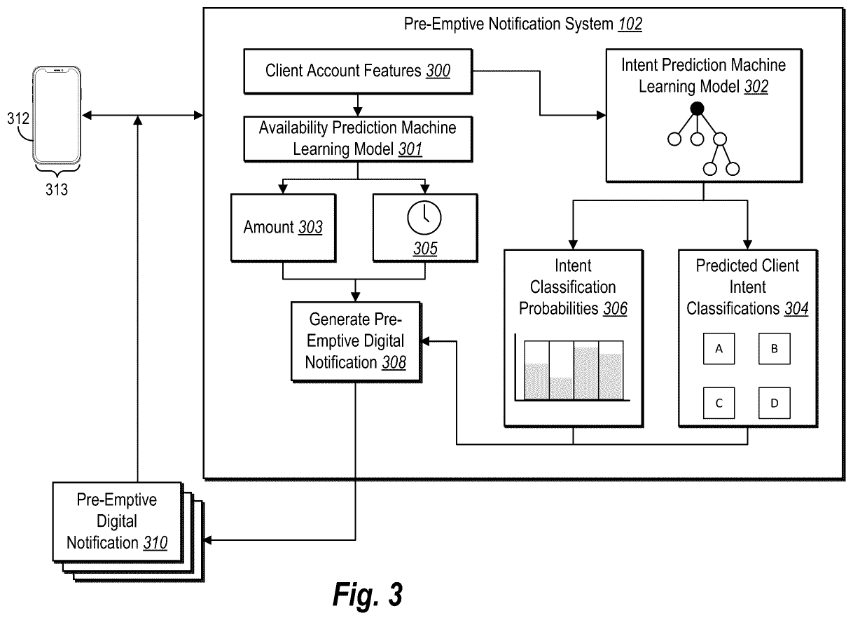

For example, with regard to FIG. 2, the pre-emptive notification system 102 performs an act 204 of determining account features. For instance, the pre-emptive notification system 102 can extract a recent schedule of direct deposits for a client account corresponding to the client device 214. Similarly, the pre-emptive notification system 102 can determine recent activity via a mobile application on the client device. Additional detail regarding determining account features is provided below (e.g., in relation to FIG. 3).

As illustrated, the pre-emptive notification system 102 utilizes the account features with the availability prediction machine learning model 206 and the intent prediction machine learning model 208 to perform an act 210 of determining a pre-emptive digital notification. For example, the availability prediction machine learning model 206 can analyze one or more account features and generate a predicted asset availability time. To illustrate, the pre-emptive notification system 102 can determine an anticipated time that a direct deposit amount will be available via the client account. Additional detail regarding an availability prediction machine learning model and predicted asset availability time is provided below (e.g., in relation to FIG. 3).

In addition, the pre-emptive notification system 102 utilizes the account features with the intent prediction machine learning model 208 to determine a predicted intent classification for the client device 214. For example, the intent prediction machine learning model 208 can analyze the account features and determine that the client device 214 has an intent to check on a direct deposit status. The pre-emptive notification system 102 can also determine an intent classification probability. For example, the pre-emptive notification system 102 can determine that the client device 214 has an intent to check on a direct deposit status with an intent classification probability of 90%. Additional detail regarding an intent prediction machine learning model 208 is provided below (e.g., in relation to FIG. 3).

As shown, the pre-emptive notification system 102 also performs an act 210 of determining a pre-emptive digital notification. For example, the pre-emptive notification system 102 can determine a pre-emptive digital notification that references the predicted intent classification. For instance, upon determining the predicted intent classification relates to a direct deposit status, the pre-emptive notification system 102 can generate a pre-emptive digital notification that references the direct deposit status. Moreover, the pre-emptive notification system 102 can also determine the pre-emptive digital notification based on the predicted asset availability time. For example, the pre-emptive digital notification can include a reference to the predicted asset availability. Additional detail regarding determining pre-emptive digital notifications is provided below (e.g., in relation to FIG. 3).

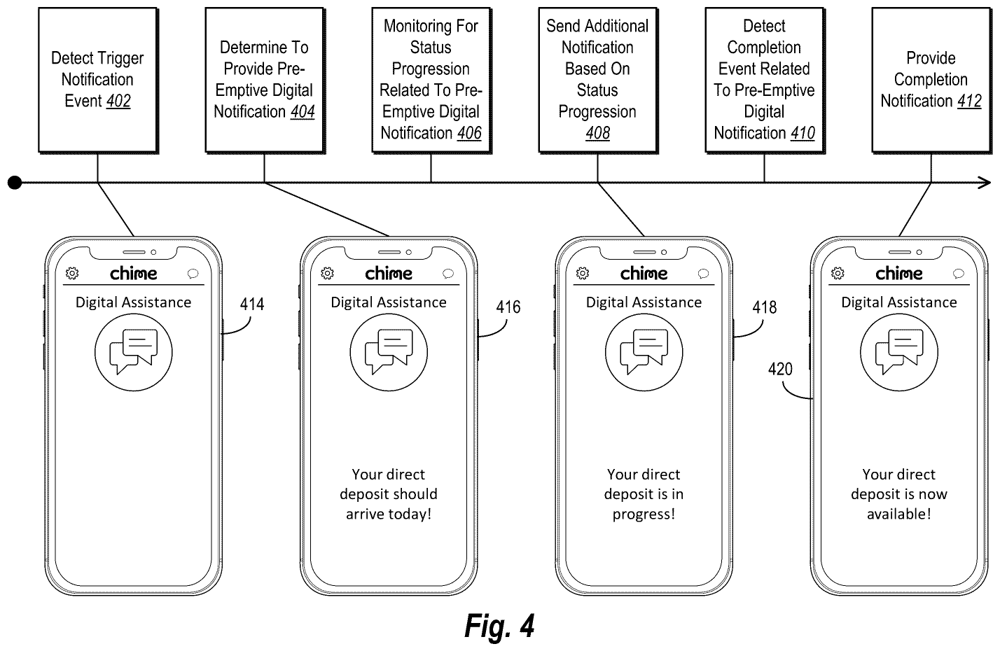

Upon determining the pre-emptive notification, the pre-emptive notification system 102 also performs an act 212 of providing the pre-emptive notification to the client device 214. For example, the pre-emptive notification system 102 selects a triggering notification event. Moreover, in response to detecting a triggering notification event, the pre-emptive notification system 102 provides the pre-emptive digital notification to the client device 214. Additional detail regarding providing notifications is provided below (e.g., in relation to FIG. 4).

As mentioned above, FIG. 3 provides additional detail regarding utilizing machine learning models to provide pre-emptive digital notifications in accordance with one or more embodiments. For example, as illustrated in FIG. 3, the pre-emptive notification system 102 extracts account features 300. For example, the pre-emptive notification system 102 determines the identity of the client device 312 either through a device application or through client provided credentials.

Upon determining a digital account or identity corresponding to the client device 312, the pre-emptive notification system 102 extracts the account features 300 corresponding to a digital account of the client device 312 or the device application. For example, the account features 300 can include previous interactions between the client device 312 and the pre-emptive notification system 102, a value metric of the digital account, an account status, enrollment activity/status, or recent activity of the digital account. For example, the account features 300 can include the last balance, transaction activity, prior or recent direct deposit activity, a maximum/minimum balance (within a threshold time), a maximum/minimum transaction amount (within a threshold time), a number of previous interactions, time since the last dispute update (e.g., a status update corresponding to a dispute), mobile check deposit activity, a fraud or risk score, and/or a number of previous interactions. The account features 300 can include interactive digital text threads (e.g., prior chatbot contacts and intents), calls (e.g., prior dispositions of calls with an interactive voice response system or agent), transactions, card orders and activations, disputes, messages (e.g., customer service topics), account views, log ins, low balance events, authorizations, web contacts, account settings views, settlements, card activity, account creations, or home page views.

The pre-emptive notification system 102 can extract the account features 300 from a variety of sources, including a digital account corresponding to a user, the client device 312, and/or a database of historical interactions or information pertinent to a user/client device. For instance, pre-emptive notification system 102 can extract the account features 300 from previous interactions with the client device 312 such as phone calls, online-chat sessions on the client device 312 or the client application 313, or user interactions with user interfaces of the device application 313.

Similarly, the pre-emptive notification system 102 can extract the account features 300 from a value metric such as an account balance for a digital account, the value of a direct deposit, the value of a transaction made on the digital account, the value of interest accrued on a digital account, or the value of fees owed. Moreover, the pre-emptive notification system 102 can extract the account features 300 from an account status such as whether an account is active, closed, temporarily disabled, on hold, or in default. Furthermore, the pre-emptive notification system 102 can extract the account features 300 from recent activity such as the client device 312 contacting the pre-emptive notification system 102 or entering an online-chat session (interactive digital text thread) within the last 5 hours. In addition, the account features 300 can include information regarding the client device, such as device type (e.g., smartphone or personal computer), operating system, or application version. Moreover, the account features 300 can include user attributes (e.g., age, income, location, etc.).

In some implementations, the pre-emptive notification system 102 extracts client features corresponding to base limit value of an account (e.g., a “SpotMe” amount). In particular, the pre-emptive notification system can utilize a base limit value, an amount of base limit value utilized, a number of base limit increases transmitted to or from a user account, as described by GENERATING USER INTERFACES COMPRISING DYNAMIC BASE LIMIT VALUE USER INTERFACE ELEMENTS DETERMINED FROM A BASE LIMIT VALUE MODEL, U.S. application Ser. No. 17/519,129, filed Nov. 4, 2021 and DETERMINING BASE LIMIT VALUES FOR CONTACTS BASED ON INTER-NETWORK USER INTERACTIONS, U.S. application Ser. No. 17/656,816, filed Mar. 28, 2022, which are expressly incorporated by reference herein in their entirety. The pre-emptive notification system 102 can also utilize activity or usage of other features or services of the inter-network facilitation system 104 (e.g., an account for transferring assets or paying friends or a credit card backed by a secured account).

In one or more embodiments, the pre-emptive notification system 102 extracts the account features 300 by comparing historical events/features with current features. For example, the account features 300 can include the time that has passed since a previous event (e.g., time since a previous call, a previous transaction, a previous dispute, a previous message, a previous viewing of an account, a previous log in, a low balance event, a previous authorization, a previous web contact, a previous viewing of account settings, a previous settlement, a card was frozen/unfrozen, an account was created, or a home page was viewed). The pre-emptive notification system 102 can also extract other client features such as a transaction amount (over the last threshold period, such as 128 days), a number of views (e.g., a number of home views or spending account views within the last 128 days), or a range over mean balance within a threshold time period.

As shown in FIG. 3, upon determining the account features 300, the pre-emptive notification system 102 utilizes the availability prediction machine learning model 301 to determine a predicted asset availability time. As shown, the predicted asset availability time can include an amount 303 and a time 305. For example, the predicted asset availability time can include a prediction of a direct deposit amount and a day/time that the direct deposit amount will be available via a client account.

As mentioned above, the availability prediction machine learning model 301 can include a variety of machine learning model architectures. For example, in some implementations, the availability prediction machine learning model 301 includes a decision tree model, such as XGBoost, CatBoost, or LightGBM. In some implementations, the availability prediction machine learning model 301 includes a convolutional neural network that generates a predicted time (e.g., time classification) and/or probability indicating the likelihood that an account asset will become available via a client account.

In some implementations, the availability prediction machine learning model includes a recurrent neural network, such as an LSTM. For instance, the pre-emptive notification system 102 can utilize an LSTM that analyzes a sequence of direct deposits through individual neural network units. These units can generate latent feature vectors that are passed to subsequent units. In some implementations, the pre-emptive notification system 102 utilizes a bi-directional LSTM that passes latent feature vectors through these neural network units in a forward manner and then in a backward manner. Thus, each unit can consider sequential features from sequential data.

The LSTM can then utilize these units to generate a prediction of the next item in the sequence. For example, the LSTM can predict a new direct deposit time (and/or amount) based on the sequence of previous direct deposit times based on the latent feature vectors from the sequential units of the LSTM. Thus, the pre-emptive notification system 102 can utilize a variety of machine learning model architectures to generate a predicted asset availability time.

As illustrated in FIG. 3, upon determining account features 300, the pre-emptive notification system 102 also utilizes the intent prediction machine learning model 302 to generate predicted client intent classifications and/or intent classification probabilities. In particular, the pre-emptive notification system 102 utilizes the intent prediction machine learning model 302 to analyze the account features 300. For example, the pre-emptive notification system 102 can encode the account features 300 (e.g., using one hot encoding, an encoding layer, or a vector mapping) and then process the encoding utilizing the intent prediction machine learning model 302.

The pre-emptive notification system 102 can utilize a variety of machine learning models to analyze the account features 300. With regard to FIG. 3, the intent prediction machine learning model 302 is a decision tree, such as a random forest model or a boosted gradient decision tree. For instance, in some implementations, the pre-emptive notification system utilizes XGBoost, CatBoost, or LightGBM machine learning model architectures. Accordingly, the pre-emptive notification system 102 feeds the account features 300 to input channels of the machine learning model. The machine learning model then utilizes learned nodes within one or more decision trees to generate a predicted classification and corresponding probability or likelihood. In other implementations the pre-emptive notification system 102 can utilize a neural network, such as a convolutional neural network, or other machine learning model to process the account features 300.

As shown in FIG. 3, the pre-emptive notification system 102 utilizes the intent prediction machine learning model 302 to generate the predicted client intent classifications 304. The predicted client intent classifications 304 can include a variety of dispositions or purposes for a client interaction. For example, the pre-emptive notification system 102 utilizes the intent prediction machine learning model 302 to predict a client intent of checking on a direct deposit status. In other implementations, the pre-emptive notification system predicts an intent classification of checking on status of a dispute, becoming eligible for a base limit value (e.g., SpotMe), becoming eligible for credit builder (e.g., a credit card with a linked, secured cash account for building credit), setting up direct deposit, depositing money into an account, initiating or checking on a mobile check deposit, initiate a dispute (e.g., regarding a charge or fee), checking on a lost card, activating a card, requesting information regarding a recent deposit, inquiring regarding a recent statement, opening a new account, closing an account, or some other intent. Similarly, client intent classifications can include an account update, referral bonus query, transfer status, atm location query, fee information (e.g., information regarding one or more fees associated with the account), check status (e.g., whether or not a check has cleared an account), interaction history (e.g., information regarding recent transactions or other interactions), order status (e.g., status of a particular order or transaction), and activation (e.g., activation of an account, product, card, or service).

In addition to the predicted client intent classifications 304, the intent prediction machine learning model 302 also generates the intent classification probabilities 306. The intent classification probabilities 306 reflect likelihoods that the predicted client intent classifications 304 correspond to the actual intent of the client. Thus, if the pre-emptive notification system 102 predicts “direct deposit status” as the client device's intent, the pre-emptive notification system also generates a corresponding probability (e.g., 45%) as a level of confidence.

As shown, the pre-emptive notification system 102 generates a plurality of predicted client intent classifications and corresponding intent classification probabilities. For example, the pre-emptive notification system 102 utilizes the intent prediction machine learning model 302 to generate multiple predicted client intent classifications with a corresponding probability distribution for the predicted classifications.

In some embodiments, the pre-emptive notification system 102 utilizes the intent prediction machine learning model 302 to predict the intent and/or whether a client intends to initiate a query regarding the intent. Thus, for example, the intent prediction machine learning model 302 can generate an intent classification probability that indicates the likelihood that the client will initiate a query regarding a particular intent (e.g., if the pre-emptive notification system 102 does not transmit a pre-emptive digital notification).

As shown, the pre-emptive notification system 102 also performs an act 308 of generating a pre-emptive digital notification. In particular, the pre-emptive notification system 102 generates the pre-emptive digital notification based on the predicted client intent classifications 304, the intent classification probabilities 306, and/or the predicted asset availability time.

For example, in one or more embodiments, the pre-emptive notification system 102 compares the intent classification probabilities in generating/selecting the pre-emptive digital notification. To illustrate, the pre-emptive notification system 102 can select one or more predicted intent classifications with the highest intent classification probability and generate one or more pre-emptive digital notifications regarding the one or more predicted intent classifications.

In some implementations, the pre-emptive notification system 102 only generates pre-emptive digital notifications for certain predicted intent classifications. For instance, the pre-emptive notification system 102 will generate a pre-emptive digital notification for a direct deposit intent classification (e.g., when the direct deposit intent classification has the highest classification probability) but will not generate a pre-emptive digital notification for other classifications. In some embodiments, the pre-emptive notification system 102 has a set of classifications that correspond to pre-emptive digital notifications and a set of classifications that do not correspond to pre-emptive digital notifications.

In one or more embodiments, the pre-emptive notification system 102 selects a pre-emptive digital notification utilizing an intent classification threshold. To illustrate, the pre-emptive notification system 102 can determine an intent classification threshold of 80%. The pre-emptive notification system 102 can then compare intent classification probabilities (i.e., the intent classification probabilities 306) with the intent classification threshold. Thus, if the pre-emptive notification system 102 determines that one or more of the intent classification probabilities 306 satisfy the intent classification threshold (e.g., 80%) the pre-emptive notification system 102 can generate a pre-emptive digital notification. If the pre-emptive notification system 102 determines that one or more of the intent classification probabilities 306 (e.g., 5%) does not satisfy the intent classification threshold (e.g., 80%) the pre-emptive notification system 102 can withhold a pre-emptive digital notification.

The pre-emptive notification system 102 can determine the intent classification threshold in a variety of ways. For example, in some implementations the pre-emptive notification system 102 determines the intent classification threshold based on user input (e.g., a user interaction selecting a particular threshold). In other embodiments, the pre-emptive notification system 102 determines the intent classification threshold based on historical user interactions. For example, the pre-emptive notification system 102 can monitor a number of client queries at different threshold levels and select a threshold level that results in fewer (e.g., minimum) queries.

As shown, the pre-emptive notification system 102 also utilizes the predicted asset availability time to generate the pre-emptive digital notification. For example, the pre-emptive notification system 102 generates a pre-emptive digital notification that references predicted asset availability time. For example, if the pre-emptive notification system 102 determines a predicted asset availability time of 1:00 the next day, the pre-emptive notification system 102 can generate a pre-emptive digital notification that includes, “It looks like your direct deposit will be available at 1:00 tomorrow. Just as a reminder we do not hold your direct deposits!”

In one or more embodiments, the pre-emptive notification system 102 generate a pre-emptive digital notification upon comparing the predicted asset availability time with a threshold time gap. For example, the pre-emptive notification system 102 will generate the pre-emptive digital notification upon determining that the current time is within the threshold time gap relative to the predicted asset availability time. To illustrate, the pre-emptive notification system 102 generates the pre-emptive digital notification only when the current time is within 12 hours of the predicted asset availability time.

As illustrated in FIG. 3, the pre-emptive notification system 102 also provides a pre-emptive digital notification 310 to the client device 312. The pre-emptive notification system 102 can provide the pre-emptive digital notification 310 in a variety of forms, including as a badge, notification, text message, instant message, email, or other digital communication. In one or more implementations, the pre-emptive digital notification 310 includes selectable user interface elements. For example, the pre-emptive digital notification 310 includes a selectable element that includes a link to check a current account status or direct deposit status.

In some circumstances, the pre-emptive notification system 102 includes an option to initiate a client-agent response session. In particular, the pre-emptive notification system 102 includes an option to initiate an audio conversation (e.g., telephone or digital audio conversation) or a live chat session between the agent device and the client device. In such an embodiment, the pre-emptive notification system 102 can also provide an indication of one or more predicted intent classifications to the agent device to facilitate the client-agent response session. For example, if the pre-emptive notification system 102 determines “direct deposit status” as the predicted client intent classification with the corresponding intent classification probability of 85%, the pre-emptive notification system provides both the predicted client intent classification and the intent classification probability to the agent device. In particular, the provided probability allows the agent device to assess the confidence of the provided predicted client intent classifications.

The pre-emptive notification system 102 can also intelligently select a time to transmit the pre-emptive digital notification 310. As mentioned above, in some implementations the pre-emptive notification system 102 utilizes a threshold time gap to distribute the pre-emptive digital notification 310. For example, the pre-emptive notification system 102 provides the pre-emptive digital notification 310 a certain time prior to the predicted asset availability time (e.g., 24 hours, 12 hours, 6 hours, or 1 hour prior to the predicted asset availability time).

In some embodiments, the pre-emptive notification system 102 transmits the pre-emptive digital notification 310 upon determining that an intent classification probability exceeds a threshold probability. For example, the pre-emptive notification system 102 only transmits the pre-emptive digital notification 310 upon determining that there is a 90% probability that the client will initiate a query regarding a direct deposit status. In one or more embodiments, the pre-emptive notification system 102 utilizes a unique machine learning model individually trained to select a distribution time for the pre-emptive digital notification 310. Thus, the pre-emptive notification system 102 can select a time for delivery/transmission of the pre-emptive digital notification 310 (e.g., a time that is most convenient or likely to receive a user interaction from the client device).

As described above, the pre-emptive notification system 102 can use a variety of techniques to determine, generate, and transmit pre-emptive notifications to client devices associated with client accounts. FIG. 4 describes additional techniques the pre-emptive notification system 102 can use to detect a trigger notification event that indicates a need to potentially provide a pre-emptive digital notification. Furthermore, FIG. 4 describes monitoring a status of progression related to a pre-emptive digital notification, and based on the status, determining to send one or more additional digital notifications. For example, the pre-emptive notification system 102 can detect a trigger event related to a predicted asset availability (e.g., such as a direct deposit). As described above, the system 102 can provide a pre-emptive digital notification related to the predicted asset availability, and in addition, the pre-emptive notification system 102 can monitor the status of the predicated asset availability to provide additional pre-emptive digital notifications related to a progression of the asset availability over time.

In particular, and as illustrated in FIG. 4, the pre-emptive notification system 102 can detect a trigger notification event 402. A trigger notification event includes any detectable signal or feature associated with a client account that pre-emptive notification system 102 uses, at least in part, to determine to provide a pre-emptive digital notification. Examples of a trigger notification event can include an application initiation event that indicates initiation of a session within an application of a client device corresponding to a client account (e.g., opening a client application). In the same or other embodiments, detecting a trigger notification event can include the pre-emptive notification system 102 detecting a particular user action within a client application (e.g., navigating to an account balance UX within the client application). In addition to a specific action within an application, the pre-emptive notification system 102 can detect a trigger notification event based on the number of times within a defined period of time a user attempts to access information or perform a particular functionality from within the application. For example, the pre-emptive notification system 102 can detect that a user has checked their checking account balance a defined number of times (e.g., 3) within a defined time (e.g., 2 hours), which satisfies a defined trigger notification event. In some embodiments, the trigger notification event can include user inactivity or user inaction (e.g., idle time periods of no user activity within a client application, a time period associated with no account status updates, meaning no deposits, withdrawals, or other use of the client account).

In addition to user action within a client application, the pre-emptive notification system 102 can detect trigger notification events related to a particular status associated with a client account (e.g., account balance, transfer notifications, transfer amounts, credit usage, account history, or any statuses associated with a client account). For example, detecting a trigger notification event can include detecting a historical pattern of asset availability (e.g., direct deposits), and determining that based on the historical pattern, a predicted future asset availability. Accordingly, the pre-emptive notification system 102 can determine that a client account has historically received a direct deposit on a particular day each month and based on detecting that the current date is within some threshold time of the determined day, the pre-emptive notification system 102 can detect the trigger notification event associated with the expected direct deposit.

In some implementations, a trigger notification event can include a particular time trigger that is independent of a user interaction. For example, a trigger notification event can originate from a routine exogenous source. In some implementations, the trigger notification event includes a recurring time, such as once an hour or once a day. Similarly, the trigger notification event can include triggering information coming from another service, such as from payroll or processing sources. In some implementation, the

As shown in FIG. 4, a user can open a client application on the client device and/or access a digital assistance UI/UX 414 within the application, which causes the pre-emptive notification system 102 to detect a trigger notification event 402. Upon detecting the trigger notification event 402, the pre-emptive notification system 102 determines to provide a pre-emptive digital notification 404, as described in detail above with respect to FIGS. 2 and 3. For instance, the pre-emptive notification system 102 can determine to provide a pre-emptive digital notification 416 associated with an asset availability for a client account (i.e., “Your direct deposit should arrive today!”). Additional types of notifications can vary depending on the triggering notification event that the pre-emptive notification system 102 detects, and the notification illustrated in FIG. 4 is for illustration of the principles and techniques described herein.

Upon providing a pre-emptive digital notification, the pre-emptive notification system 102 can keep track of a status of an event or issue related to the pre-emptive notification. For instance, and as illustrated in FIG. 4, the pre-emptive notification system 102 can monitor for status progression related to the pre-emptive digital notification 406. For example, many examples of pre-emptive digital notifications correspond to a predicted future event or action related to a client account. Accordingly, the pre-emptive notification system 102 can continue to monitor the status of the predicted future event and provide status updates in the form of additional notifications.

For example, and as illustrated in FIG. 4, after the pre-emptive notification system 102 provides the pre-emptive digital notification related to a predicted asset availability corresponding to the user account, the pre-emptive notification system 102 continues to monitor for status progression of the predicted asset availably. In other examples, the original pre-emptive digital notification may have been associated with a charge dispute associated with the client account, at which point, the pre-emptive notification system 102 continues to monitor the dispute. Overall, in some embodiments, the pre-emptive notification system 102 system does not simply provide a single notification, but rather, when circumstances are such that a user would be interested in the progression of an issue associated with a pre-emptive notification, the pre-emptive notification system 102 can continue to monitor the progression to provide additional updates.

Based on monitoring for status progression related to a pre-emptive digital notification, the pre-emptive notification system 102 can send an additional notification. As illustrated in FIG. 4, the pre-emptive notification system 102 can send an additional notification based on determining a status progression 408. For example, and as further illustrated in FIG. 4, the pre-emptive notification system 102 can monitor the status of an asset availability to determine that a deposit transfer that will result in a completed direct deposit has been initiated within the inter-network facilitation system 104. In particular, the pre-emptive notification system 102 can determine that in addition to the predicted asset availability time which caused the system to send the pre-emptive digital notification 416, there is now direct evidence of the actual asset availability transfer. Accordingly, the pre-emptive notification system 102 can determine to send the additional notification 418 (i.e., Your direct deposit is in progress). By continuing to proactively provide notifications to a client device associated with a client account, the pre-emptive notification system 102 reduces or eliminates the need for a user to continue to open a client application to check a status, contact customer support, and accordingly reduces the amount or computational resources needed to effectively manage a client account, as described in additional detail above.

The pre-emptive notification system 102 can continue to monitor for status progression and provide any number of additional notifications corresponding to any number of status progression updates. In some examples, the pre-emptive notification system 102 can provide an additional notification based on a lack of status progression. For example, the pre-emptive notification system 102 can determine that an expected status progression event has not occurred within a predicted time period (i.e., a status progression time threshold), and based on the nonoccurrence of the status progression, the pre-emptive notification system 102 can provide an additional notification. Thus, if the pre-emptive notification system 102 detects satisfaction of a progression time threshold without detecting the status progression event, the pre-emptive notification system 102 can provide an additional notification (e.g., “Your direct deposit has not been received and is past due”).

As it relates to the specific example illustrated in FIG. 4, the pre-emptive notification system 102 can determine that the transfer initiation event associated with the expected direct deposit has yet to occur within the system by a predicted time (i.e., the status progression time threshold). Upon determining the lack of the transfer initiation event, the pre-emptive notification system 102 can provide an additional notification indicating that the expected direct deposit may be delayed. In some embodiments, the pre-emptive notification system 102 can send escalating notifications regarding a predicted event when the predicted event is not transpiring as expected. For example, the pre-emptive notification system 102 can provide a level 1 notification, sent after a first time period, indicating that the direct deposit may be delayed, but that the system will continue to provide updates. A level 2 notification, sent after a second time period longer than the first time period, may indicate that the user should check on the status of the source of the direct deposit. Finally, the pre-emptive notification system 102 can provide a level 3 notification, after a third time period longer than the second time period, indicating that the predicted asset availability of the direct deposit appears to have not been accurate, where the level 3 notification would provide sources for the user to check to see what may have caused the direct deposit to not have been received as expected.

While not illustrated in FIG. 4, the pre-emptive digital notification and the additional notification can include selectable elements within the respective notifications that allow a user to indicate whether or not the particular notification is relevant to a user. For example, the pre-emptive digital notification could include an “ignore” selectable element. Upon detecting an indication of a user selection of the “ignore” selectable element, the pre-emptive notification system 102 ceases to monitor for status progression related to the pre-emptive digital notification. On the contrary, the pre-emptive notification system 102 can include a selectable element associated with the message “keep me updated.” Upon detecting an indication of a user selection of the “keep me updated” selectable element, the pre-emptive notification system 102 continues to monitor for status progression and send corresponding additional notifications based on the status updates.

In addition to monitoring, the pre-emptive notification system 102 can detect a completion of an issue related to the pre-emptive digital notification. For example, and as illustrated in FIG. 4, the system can detect a completion event related to the pre-emptive digital notification 410. In other words, and as described in detail above, the pre-emptive digital notification is provided based on a predicted need or outcome related to a client account. The pre-emptive notification system 102 can detect when that predicted need or outcome occurs. For example, and continuing with the example described in FIG. 4, the pre-emptive notification system 102 can detect that the direct deposit has funded into the client account. In other examples, the completion event can be related to a status update that indicates the original reason for the pre-emptive digital notification is no longer active.

Based upon detecting the completion event, the pre-emptive notification system 102 can provide a completion notification 412, as illustrated in FIG. 4. For example, and as just discussed above, the pre-emptive notification system 102 can provide the notification 420 indicating “Your direct deposit is now available!” Accordingly, FIG. 4 illustrates that the pre-emptive notification system 102 can not only provide a single pre-emptive digital notification, but in addition, the pre-emptive notification system 102 can continue to monitor a status related to the pre-emptive digital notification and continue to provide additional notifications until the pre-emptive notification system 102 detects a completion event.

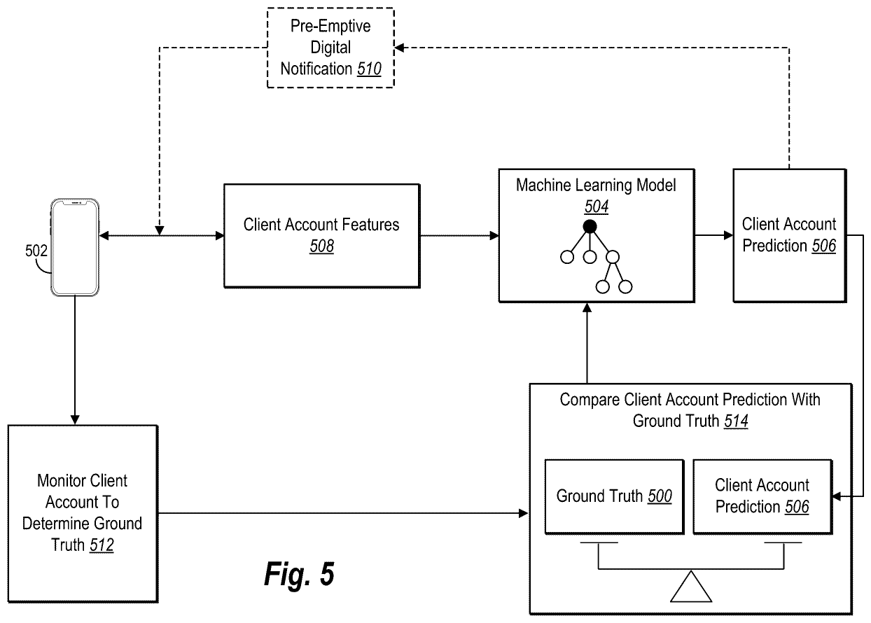

As discussed above, the pre-emptive notification system 102 can train machine learning model for generating predicted intent classifications and/or predicted asset availability times. For example, FIG. 5 illustrates an overview of training a machine learning model 504 (e.g., the availability prediction machine learning model 206 and/or the intent prediction machine learning model 208) in accordance with one or more embodiments.

As illustrated in FIG. 5, the pre-emptive notification system 102 extracts client features 508 that correspond with the client device 502 and utilizes the machine learning model 504 to generate client account predictions 506. For example, the machine learning model 504 can extract client features 508 (e.g., the client account features 300) and generate predicted intent classifications or predicted asset availability times as the client account predictions 506.

As shown, the pre-emptive notification system 102 performs an act 512 of monitoring a client account to determine a ground truth (and the accuracy of the client account predictions 506). For example, the pre-emptive notification system 102 can monitor a client account and determine a ground truth asset availability time (e.g., the time that a direct deposit actually becomes available). Similarly, as illustrated, the pre-emptive notification system 102 can provide a pre-emptive digital notification 510 to the client device 502 and monitor user interactions confirming (or denying) the accuracy of a predicted client intent classifications. Moreover, the pre-emptive notification system 102 can monitor additional user interactions, such as information ultimately provided to the client device 502 or information requested from an agent device. The pre-emptive notification system 102 can determine a ground truth intent from these interactions. Accordingly, the pre-emptive notification system 102 monitors a client account to determine a ground truth 500.

As mentioned, the pre-emptive notification system 102 can further train the machine learning model 504 based on the ground truth 500. For example, the pre-emptive notification system 102 performs an act 514 of comparing the client account prediction with the ground truth 500. In particular, the pre-emptive notification system 102 compares a predicted asset availability time with a ground truth asset availability time. Similarly, the pre-emptive notification system 102 compares a predicted client intent classification and a ground truth client intent.

In one or more embodiments, the pre-emptive notification system 102 compares the prediction and ground truth with a loss function. A loss function can determine a measure of loss between a prediction and ground truth. In some implementations, the pre-emptive notification system 102 utilizes a multi-log loss for multi-class classification. The loss function can also include mean absolute error (L1) loss functions, mean squared error (L2) loss functions, cross entropy loss functions, or Kullback-Leibler loss.

The pre-emptive notification system 102 trains the machine learning model 504 based on the comparison between the client account prediction 506 and the ground truth 500. For example, the pre-emptive notification system 102 can modify nodes of a decision tree model (e.g., a random forest model) based on the measure of loss from the loss function. Similarly, the pre-emptive notification system 102 can modify internal weights or parameters of a neural network (e.g., via back propagation) to reduce the measure of loss. On subsequent interactions between client devices and the pre-emptive notification system 102, the machine learning model 504 provides improved predictions.

FIGS. 1-5, the corresponding text, and the examples provide a number of different systems, methods, and non-transitory computer readable media for generating personalized digital text reply options in an automated interactive digital text thread. In addition to the foregoing, embodiments can also be described in terms of flowcharts comprising acts for accomplishing a particular result. For example, FIG. 6 illustrates a flowchart of an example sequence of acts in accordance with one or more embodiments.

While FIG. 6 illustrates acts according to some embodiments, alternative embodiments may omit, add to, reorder, and/or modify any of the acts shown in FIG. 6. The acts of FIG. 6 can be performed as part of a method. Alternatively, a non-transitory computer readable medium can comprise instructions, that when executed by one or more processors, cause a computing device to perform the acts of FIG. 6. In still further embodiments, a system can perform the acts of FIG. 6. Additionally, the acts described herein may be repeated or performed in parallel with one another or in parallel with different instances of the same or other similar acts.

FIG. 6 illustrates an example series of acts 600 for intelligently transmitting pre-emptive digital notifications to client devices across computer networks in accordance with one or more embodiments. The series of acts 600 can include an act 602 of determining account features corresponding to a client account; an act 604 of generating, from the account features, a digital asset availability prediction utilizing an availability prediction machine learning model; an act 606 of generating, from the account features, a digital intent classification utilizing an intent prediction machine learning model; and an act 608 of providing a pre-emptive digital notification regarding the predicted asset availability time based on the digital asset availability prediction and the digital intent classification.

For example, in one or more embodiments, the acts 602-608 include determining account features corresponding to a client account of a client; generating, from the account features, a digital asset availability prediction indicating a predicted asset availability time of an account asset corresponding to the client account utilizing an availability prediction machine learning model; generating, from the account features, a digital intent classification for the client utilizing an intent prediction machine learning model; and providing, to a client device corresponding to the client account, a pre-emptive digital notification regarding the predicted asset availability time based on the digital asset availability prediction and the digital intent classification.

In addition, in one or more embodiments, the series of acts 600 includes generating the digital intent classification by: generating a plurality of digital intent classification predictions and a plurality of intent classification probabilities; and comparing the plurality of intent classification probabilities to a threshold classification probability.

Furthermore, in some embodiments, the series of acts 600 includes selecting a triggering notification event; and in response to detecting the triggering notification event, providing the pre-emptive digital notification. Moreover, in one or more implementations, the series of acts 600 includes selecting the triggering notification event by selecting an application initiation event comprising initiation of a session within an application of the client device corresponding to the client account.

In some implementations, the series of acts 600 includes providing, to the client device, an additional notification regarding the account asset upon detecting that the account asset is available via the client account. In addition, in some embodiments, the series of acts 600 includes, providing, to the client device, an additional notification upon determining that the account asset is not available by the predicted asset availability time. In one more implementations, the series of acts 600 includes providing, to the client device, an additional notification upon determining at least one of: a status progression event for the account asset; or satisfaction of a status progression time threshold without detecting the status progression event.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 (e.g., the client device 108, or the server(s) 106) that may be configured to perform one or more of the processes described above. As shown by FIG. 7, the computing device can comprise a processor 702, memory 704, a storage device 706, an I/O interface 708, and a communication interface 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, storage device 706 can comprise a non-transitory storage medium described above. The storage device 706 may include a hard disk drive (“HDD”), flash memory, a Universal Serial Bus (“USB”) drive or a combination of these or other storage devices.

The computing device 700 also includes one or more input or output interface 708 (or “I/O interface 708”), which are provided to allow a user (e.g., requester or provider) to provide input to (such as user strokes), receive output from, and otherwise transfer data to and from the computing device 700. These I/O interface 708 may include a mouse, keypad or a keyboard, a touch screen, camera, optical scanner, network interface, modem, other known I/O devices or a combination of such I/O interface 708. The touch screen may be activated with a stylus or a finger.

The I/O interface 708 may include one or more devices for presenting output to a user, including, but not limited to, a graphics engine, a display (e.g., a display screen), one or more output providers (e.g., display providers), one or more audio speakers, and one or more audio providers. In certain embodiments, interface 708 is configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 can provide one or more interfaces for communication (such as, for example, packet-based communication) between the computing device and one or more other computing devices 700 or one or more networks. As an example, and not by way of limitation, communication interface 710 may include a network interface controller (“NIC”) or network adapter for communicating with an Ethernet or other wire-based network or a wireless NIC (“WNIC”) or wireless adapter for communicating with a wireless network, such as a WI-FI. The computing device 700 can further include a bus 712. The bus 712 can comprise hardware, software, or both that connects components of computing device 700 to each other.

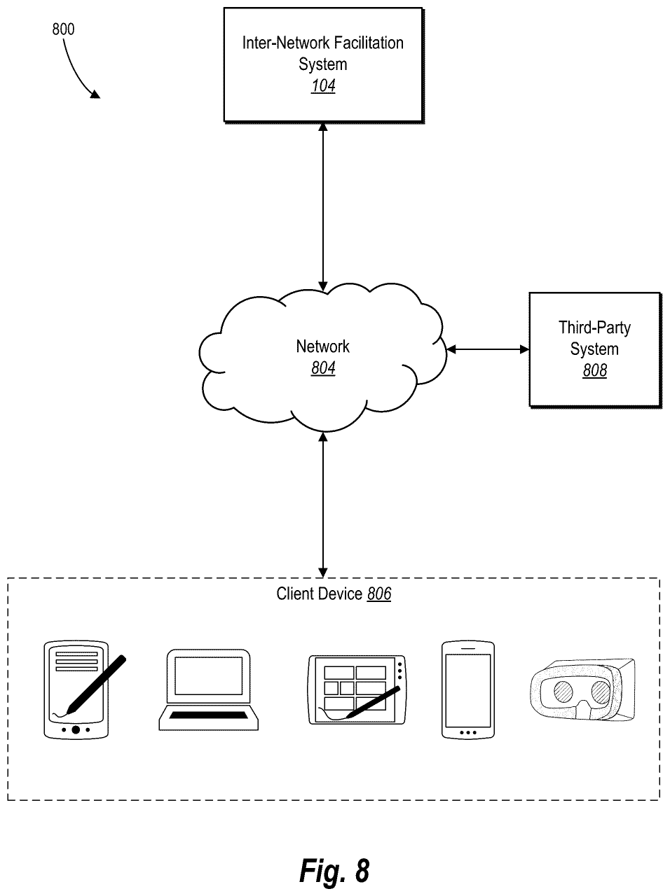

FIG. 8 illustrates an example network environment 800 of the inter-network facilitation system 104. The network environment 800 includes a client device 806 (e.g., client device 108), an inter-network facilitation system 104, and a third-party system 808 connected to each other by a network 804. Although FIG. 8 illustrates a particular arrangement of the client device 806, the inter-network facilitation system 104, the third-party system 808, and the network 804, this disclosure contemplates any suitable arrangement of client device 806, the inter-network facilitation system 104, the third-party system 808, and the network 804. As an example, and not by way of limitation, two or more of client device 806, the inter-network facilitation system 104, and the third-party system 808 communicate directly, bypassing network 804. As another example, two or more of client device 806, the inter-network facilitation system 104, and the third-party system 808 may be physically or logically co-located with each other in whole or in part.

Moreover, although FIG. 8 illustrates a particular number of client devices 806, inter-network facilitation system 104, third-party systems 808, and networks 804, this disclosure contemplates any suitable number of client devices 806, inter-network facilitation system 104, third-party systems 808, and networks 804. As an example, and not by way of limitation, network environment 800 may include multiple client device 806, inter-network facilitation system 104, third-party systems 808, and/or networks 804.

This disclosure contemplates any suitable network 804. As an example, and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806 and third-party system 808 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, the client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 8. A client device 806 may enable a network user at the client device 806 to access network 804. A client device 806 may enable its user to communicate with other users at other client devices 806.

In particular embodiments, the client device 806 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 806 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 806 one or more Hyper Text Markup Language (“HTML”) files responsive to the HTTP request. The client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 804) to link the third-party-system 808. For example, the inter-network facilitation system 104 may receive authentication credentials from a user to link a third-party system 808 such as an online bank account, credit account, debit account, or other financial account to a user account within the inter-network facilitation system 104. The inter-network facilitation system 104 can subsequently communicate with the third-party system 808 to detect or identify balances, transactions, withdrawal, transfers, deposits, credits, debits, or other transaction types associated with the third-party system 808. The inter-network facilitation system 104 can further provide the aforementioned or other financial information associated with the third-party system 808 for display via the client device 806. In some cases, the inter-network facilitation system 104 links more than one third-party system 808, receiving account information for accounts associated with each respective third-party system 808 and performing operations or transactions between the different systems via authorized network connections.

In particular embodiments, the inter-network facilitation system 104 may interface between an online banking system and a credit processing system via the network 804. For example, the inter-network facilitation system 104 can provide access to a bank account of a third-party system 808 and linked to a user account within the inter-network facilitation system 104. Indeed, the inter-network facilitation system 104 can facilitate access to, and transactions to and from, the bank account of the third-party system 808 via a client application of the inter-network facilitation system 104 on the client device 806. The inter-network facilitation system 104 can also communicate with a credit processing system, an ATM system, and/or other financial systems (e.g., via the network 804) to authorize and process credit charges to a credit account, perform ATM transactions, perform transfers (or other transactions) across accounts of different third-party systems 808, and to present corresponding information via the client device 806.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 808), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 800 either directly or via network 804. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 804.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 806. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 806. Information may be pushed to a client device 806 as notifications, or information may be pulled from client device 806 responsive to a request received from client device 806. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 806 associated with users.

In addition, the third-party system 808 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 804. A third-party system 808 can communicate with the inter-network facilitation system 104 to provide financial information pertaining to balances, transactions, and other information, whereupon the inter-network facilitation system 104 can provide corresponding information for display via the client device 806. In particular embodiments, a third-party system 808 communicates with the inter-network facilitation system 104 to update account balances, transaction histories, credit usage, and other internal information of the inter-network facilitation system 104 and/or the third-party system 808 based on user interaction with the inter-network facilitation system 104 (e.g., via the client device 806). Indeed, the inter-network facilitation system 104 can synchronize information across one or more third-party systems 808 to reflect accurate account information (e.g., balances, transactions, etc.) across one or more networked systems, including instances where a transaction (e.g., a transfer) from one third-party system 808 affects another third-party system 808.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining account features corresponding to a client account of a client;
generating, from the account features, a digital asset availability prediction indicating a predicted asset availability time of an account asset corresponding to the client account utilizing an availability prediction machine learning model;
generating, from the account features, a digital intent classification for the client utilizing an intent prediction machine learning model; and
providing, to a client device corresponding to the client account, a pre-emptive digital notification regarding the predicted asset availability time based on the digital asset availability prediction and the digital intent classification.

2. The computer-implemented method of claim 1 wherein generating the digital intent classification comprises:
generating a plurality of digital intent classification predictions and a plurality of intent classification probabilities; and
comparing the plurality of intent classification probabilities to a threshold classification probability.

3. The computer-implemented method of claim 1 further comprising:
selecting a triggering notification event; and
in response to detecting the triggering notification event, providing the pre-emptive digital notification.

4. The computer-implemented method of claim 3, wherein selecting the triggering notification event comprises selecting an application initiation event comprising initiation of a session within an application of the client device corresponding to the client account.

5. The computer-implemented method of claim 1, further comprising providing, to the client device, an additional notification regarding the account asset upon detecting that the account asset is available via the client account.

6. The computer-implemented method of claim 1, further comprising providing, to the client device, an additional notification upon determining that the account asset is not available by the predicted asset availability time.

7. The computer-implemented method of claim 1, further comprising providing, to the client device, an additional notification upon determining at least one of:
a status progression event for the account asset; or
satisfaction of a status progression time threshold without detecting the status progression event.

8. A non-transitory computer-readable medium storing instructions that, when executed by at least one processor, cause a computer system to:
determine account features corresponding to a client account of a client;
generate, from the account features, a digital asset availability prediction indicating a predicted asset availability time of an account asset corresponding to the client account utilizing an availability prediction machine learning model;
generate, from the account features, a digital intent classification for the client utilizing an intent prediction machine learning model; and
provide, to a client device corresponding to the client account, a pre-emptive digital notification regarding the predicted asset availability time based on the digital asset availability prediction and the digital intent classification.

9. The non-transitory computer-readable medium of claim 8, wherein the instructions, when executed by the at least one processor, further cause the computer system to generate the digital intent classification by:
generating a plurality of digital intent classification predictions and a plurality of intent classification probabilities; and
comparing the plurality of intent classification probabilities to a threshold classification probability.

10. The non-transitory computer-readable medium of claim 8, wherein the instructions, when executed by the at least one processor, further cause the computer system to:
select a triggering notification event; and
in response to detecting the triggering notification event, provide the pre-emptive digital notification.

11. The non-transitory computer-readable medium of claim 10, wherein the instructions, when executed by the at least one processor, further cause the computer system to select the triggering notification event by selecting an application initiation event comprising initiation of a session within an application of the client device corresponding to the client account.

12. The non-transitory computer-readable medium of claim 8, wherein the instructions, when executed by the at least one processor, further cause the computer system to provide, to the client device, an additional notification regarding the account asset upon detecting that the account asset is available via the client account.

13. The non-transitory computer-readable medium of claim 8, wherein the instructions, when executed by the at least one processor, further cause the computer system to provide, to the client device, an additional notification upon determining that the account asset is not available by the predicted asset availability time.

14. The non-transitory computer-readable medium of claim 8, wherein the instructions, when executed by the at least one processor, further cause the computer system to provide, to the client device, an additional notification upon determining at least one of:
a status progression event for the account asset; or
satisfaction of a status progression time threshold without detecting the status progression event.

15. A system comprising:
at least one processor; and
at least one non-transitory computer-readable storage medium storing instructions that, when executed by the at least one processor, cause the system to:
determine account features corresponding to a client account of a client;
generate, from the account features, a digital asset availability prediction indicating a predicted asset availability time of an account asset corresponding to the client account utilizing an availability prediction machine learning model;
generate, from the account features, a digital intent classification for the client utilizing an intent prediction machine learning model; and
provide, to a client device corresponding to the client account, a pre-emptive digital notification regarding the predicted asset availability time based on the digital asset availability prediction and the digital intent classification.

16. The system of claim 15, further comprising instructions that, when executed by the at least one processor, cause the system to generate the digital intent classification by:
generating a plurality of digital intent classification predictions and a plurality of intent classification probabilities; and
comparing the plurality of intent classification probabilities to a threshold classification probability.

17. The system of claim 15, further comprising instructions that, when executed by the at least one processor, cause the system to:
select a triggering notification event; and
in response to detecting the triggering notification event, provide the pre-emptive digital notification.

18. The system of claim 17, further comprising instructions that, when executed by the at least one processor, cause the system to select the triggering notification event by selecting an application initiation event comprising initiation of a session within an application of the client device corresponding to the client account.

19. The system of claim 15, further comprising instructions that, when executed by the at least one processor, cause the system to provide, to the client device, an additional notification regarding the account asset upon detecting that the account asset is available via the client account.

20. The system of claim 15, further comprising instructions that, when executed by the at least one processor, cause the system to provide, to the client device, an additional notification upon determining that the account asset is not available by the predicted asset availability time.
